(19) United States
(12) Patent Application Publication
(10) Pub. No.: US 2007/0209159 A1
(43) Pub. Date: Sep. 13, 2007

(54) Furniture Hinge With Spring

(76) Inventor: Luciano Salice, Carimate (IT)

Correspondence Address: GIFFORD, KRASS, SPRINKLE,ANDERSON & CITKOWSKI, P.C, PO BOX 7021, TROY, MI, 48007-7021, US

(21) Appl. No.: 10/583,826

(22) PCT Filed: Dec. 22, 2004
(86) PCT No.: PCT/EP04/53666

§ 371 Date: Jun. 19, 2006

(30) Foreign Application Priority Data
Dec. 23, 2003 (IT) RM2003A000599

(51) Int. Cl. E05F 1/12

(52) U.S. Cl. 16/277

(57) ABSTRACT

Furniture hinge with a fixing arm (1) for fixing to a piece of furniture (4), a member (7) for fixing to a door (11), linked by two rockers (5, 6), forming an articulated quadrilateral so as to allow the rotation thereof, a V-shaped spring (28, 38, 48), placed at an end of a rocker (6), with an arm of the spring resting on the member for fixing to the furniture (4) or to the door (11) and the other arm of the spring resting on one of the rockers (5, 6), so as to create a lever arm that compresses the spring (8) producing a moment in the opening direction of the door (11), when this is in the closed position.

### FIELD OF THE INVENTION

This invention relates to a hinge with spring for doors, or in general for moveable parts of furniture. In particular it relates to a hinge provided with a spring that exerts a pushing force during opening.

### PRIOR ART

Pieces of furniture housing storage spaces are often equipped with doors or leaves that open and close by rotating around a horizontal or vertical axis using a hinge mechanism. A very common system is that in which the hinges for supporting the doors in the closed position are hidden when the door of the piece of furniture is closed.

This type of hinge is widely used in the furniture industry because has a number of advantages that have contributed to its success on the market.

Some of the hinges known in the prior art are provided with different types of springs to produce a return force when the door to which they are attached is closed. This solution enables the closing of the doors on the piece of furniture in a very precise manner Unfortunately, in these cases it is almost always necessary to exert an additional external force to open the door of the piece of furniture, which entails the availability of some type of handle.

DE-U-8909532 describes a hinge with spring that exerts a pushing force exclusively in the closing direction of the door. Embodiments of hinges with spring having the double effect of exerting a closing force when the door is in the closed position and an opening force when the door is in the open position are described in documents DE-A-2505527, DE-A-2611942, DE-U-29917107. The difference between these solutions consists in the fact that in DE-U-8909532 the elastic element acts on the internal rocker that always pivots in one direction only, clockwise in the closing direction and anticlockwise in the opening direction. Furthermore the hinge in question is provided with an elastic element that is difficult to install and a rocker having a particularly complex shape and a delicate structure. Instead, in the other documents DE-A-2611942, DE-U-29917107 the elastic element acts on the external rocker that shifts pivoting direction in the final part of the door opening movement.

Furthermore, the elastic elements used in these embodiments of hinges are particularly bulky or require the use of pins or pivot points, additional or modified with respect to those one necessary for rotation of the same hinge. This fact implies higher production costs in both cases.

None of the spring devices known in the prior art are capable of exerting a pushing force on the hinge in the opening direction with the door in the closed position. However the use of doors without handles or other gripping devices, visible from the outside, may be preferable on some types of furniture and this requires the use of hinges with a spring that exerts an opening moment on the door in an initial stage of the opening movement. In this case the spring must either be separate from the hinges or the hinges must be of a relatively complex nature.

### SUMMARY OF THE INVENTION

A main purpose of this invention is to provide a hinge with pushing force in opening direction that involves limited production costs, has as many parts as possible in common with the other hinges available on the market, is versatile in terms of use and can be fitted without having to modify any of the components commonly constituting hinges so as to transform these hinges according to the required function without any significant increase in costs.

This invention, therefore, overcomes the drawbacks described above providing a hinge with spring having the characteristics set forth in claim 1.

These objectives are achieved by fitting (during the hinge assembly process) around one of the pivoting pins of the rockers an elastic element having two arms, one of which rests in stable manner on the fixed member or mobile member of the hinge, while the other one causes one of the two rockers to pivot for a short interval in the direction that generates the door opening movement, when the door is in the closed position. Opportunely the second arm of the elastic element rests directly on the back of one of the rockers Thanks to these members the hinge according to this invention is versatile and suitable for use in various alternative applications.

One important advantage of the elastic element in the hinge according to this invention is that it is fully contained within the hinge articulated joint, and it is not therefore affected either by the fixed member shape or by mobile member shape.

The arrangement according to this invention is therefore suitable for use with hinges of different shapes, for example hinges with fixed members differently bent or sloping or with differently shaped mobile members. It is also possible to transform an existing hinge with a pushing force during closing into a hinge with a pushing force during opening without changing almost any of the components of the hinge, but simply by replacing the elastic element only.

Another advantage of the hinge according to this invention is that a simple hinge, without a spring device, can be fitted with a device adapted to produce a pushing force during opening simply by inserting the elastic element and without modifying any of the hinge components. Said simple hinges are commonly manufactured to be fitted to furniture in conjunction with magnetic devices that hold the door in the closed position only. The use of the new elastic devices according to this invention enables standard hinges to be transformed into hinges with a pushing force during opening at very low cost, so that these can be used with latches on furniture with doors with no handles.

The dependent claims describe preferred embodiments of the invention.

### BRIEF DESCRIPTION OF THE DRAWINGS

Further characteristics and advantages of this invention will become clear from the detailed description of preferred, but not exclusive, embodiments of a hinge, merely illustrative and not limitative, with the help of the drawings attached hereto, in which:

FIGS. 1, 2, 3 show cross-section views of the hinge according to the invention in three different opening positions of a piece of furniture member;

FIGS. 4, 5, 6 show cross-section views of an embodiment of the hinge according to the invention in three different opening positions of a piece of furniture member;

FIG. 7 shows a cross-section view of another embodiment of the hinge according to the invention;

FIG. 8 shows a side view of an elastic element incorporated in the hinge according to the invention;

FIG. 9 shows a plan view of the element in FIG. 8;

FIG. 10 shows a plan view of an elastic element incorporated in the hinge according to the invention;

FIG. 11 shows a side view of an alternative embodiment of an elastic element incorporated in the hinge according to the invention;

FIG. 12 shows a plan view of the element in FIG. 11;

FIG. 13 shows a side view of an alternative embodiment of an elastic element incorporated in the hinge according to the invention.

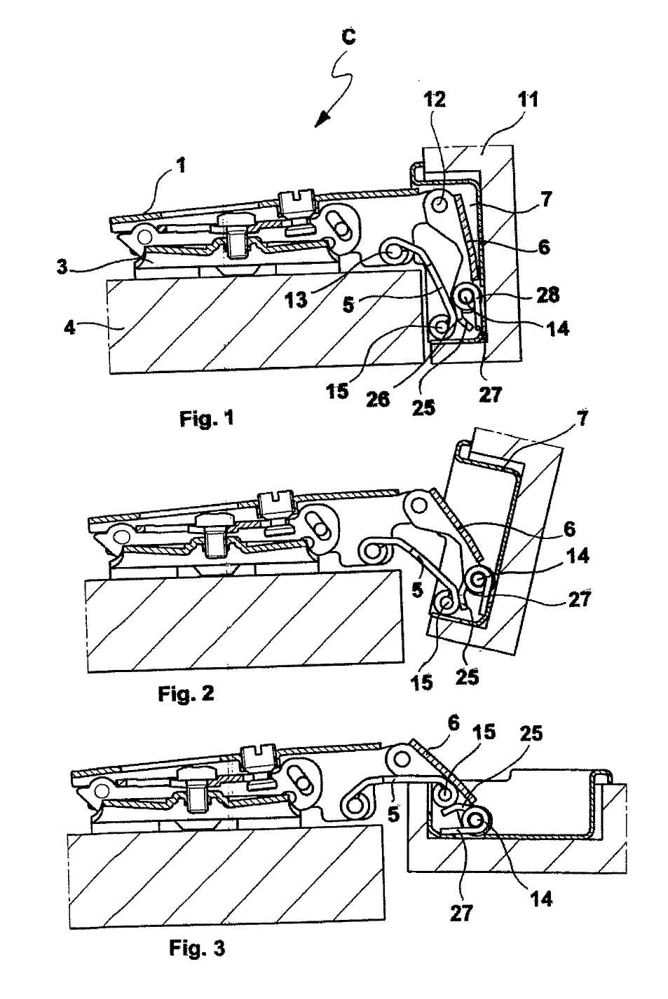

### DETAILED DESCRIPTION OF PREFERRED EMBODIMENTS OF THE INVENTION

With reference to the figures, a hinge is showed, indicated as a whole by the letter C. Said hinge comprises a fixed member, or hinge arm 1, that may be attached to a base, or plate 3, integrally fixed to a supporting wall 4, for example the side or any appropriate part of a piece of furniture. The hinge C is provided with fastening and adjusting members so that the arm 1 can be adjusted in the three directions orthogonal. There is provided a plate 2 that is used to adjust the position of the hinge in the frontal and side directions with respect to the piece of furniture, while the means for adjusting the position of the hinge in the other orthogonal direction are not illustrated in detail in the figures, as said means are known in the prior art. There are provided two rockers 5 and 6, having a respective first end pivoting around two respective pins 12, 13 housed in holes in the side walls of the arm 1. The arm 1 is linked to a box member 7, fixed to a cavity made on the internal wall of the door 11, or of any other appropriate pivoting part of the piece of furniture. The two respective second ends of the rockers 5 and 6 are housed pivoting around other two respective pins 14, 15 having axes parallel to the first two pins 12, 13. The four pins 12, 13, 14, 15 form a four-bar linkage A spring 28 is placed around a pivoting pin 14, connecting the rocker 6 to the box member 7. One of the arms 25 of the spring rests on the back of the rocker 5 and the second arm 27 rests on the box member 7.

The arm 25 has a curve 26 that defines a pivot point on the rocker 5 so as to produce a moment on the latter so that it pivots in the door opening direction until it reaches the position illustrated in FIG. 2. From this position the arm 25 of the elastic element 28 rests on the eyelet or curling of the rocker 5, being said eyelet engaged around the pivoting pin 15, and remains inactive until the door is fully open as illustrated in FIG. 3.

In this way a simple hinge or respectively a hinge with a closing device can be transformed into a hinge with a pushing force during opening simply by adding or respectively replacing the elastic element.

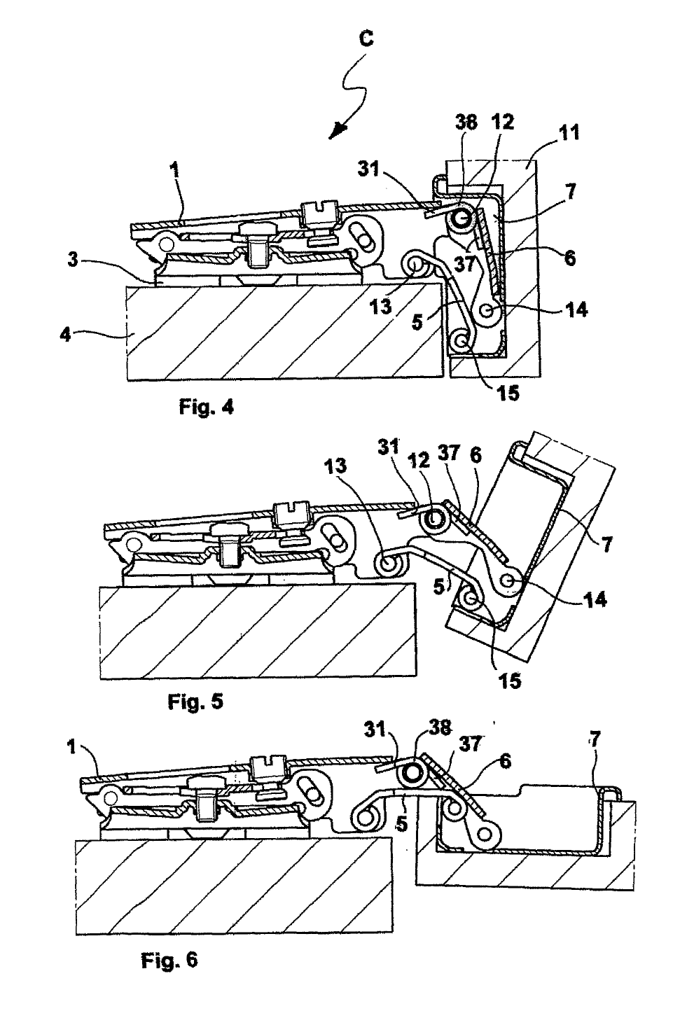

In a second embodiment, illustrated in FIGS. 4 to 6, the elastic element 38 is housed around the pivoting pin 12 and an arm thereof 31 rests on the fixed member 1 while the other arm 37 pushes from underneath the back side of the external rocker 6. The opening of the arms 31 and 37 of the elastic element 38 is so as to exert a pushing force on the rocker 6 until the position illustrated in FIG. 5. Beyond this door opening angle, approximately 15 to 20°, the elastic element 38 or spring is unloaded or the compression thereof is negligible, so that the remaining part of door pivoting freely occurs without being affected by the presence of elastic forces, unlike the hinges known in the prior art.

In FIG. 6 the arm 37 of the elastic element is slightly detached from the back of the rocker 6, so that the reversal of the pivoting direction of this rocker in the door open position is not affected by the elastic element.

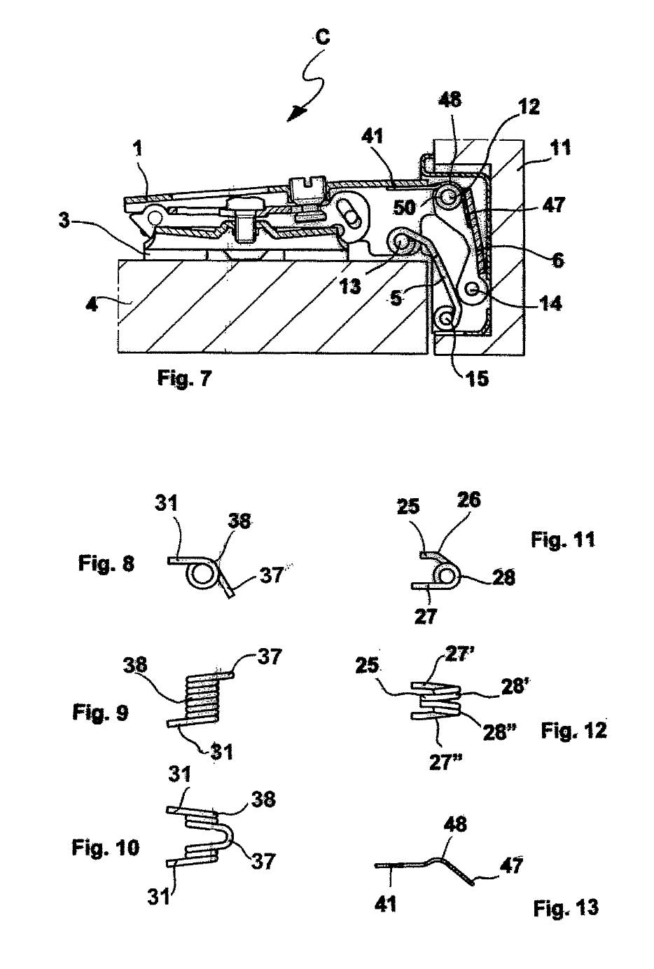

In another embodiment according to this invention, illustrated in FIG. 7, the elastic element 48 consists of a flat spring with two arms 41, 47, respectively rested on the fixed member 1 and the rocker 6. A bushing 50 may be opportunely inserted between the elastic element 48 and the pin 12. Alternatively the element 48 may be detached from the pin 12 and fastened to the hinge arm 1 according to a method known in the prior art.

FIG. 8 shows a side view of the elastic element 38 that may be manufactured in one of the types illustrated in the top views in FIG. 9 or FIG. 10. FIG. 11 shows a side view of the elastic element 26, which may consist of two symmetrical parts 28′, 28″ coupled as illustrated in FIG. 12. Finally, FIG. 13 shows the elastic element 48 consisting of a opportunely shaped flat spring.

With the arrangement of the hinge components as described above the hinge becomes extremely versatile. Its low production costs decreases the cost of the hinges in order to achieve economies of scale.

1. Furniture hinge comprising a fixing arm (1) for fixing to a piece of furniture (4), a member (7) for fixing to a door (11), a first (6) and a second (5) rocker, forming a four-bar linkage and connecting said fixing arm (1) to said member (7) for fixing to a door so as to enable reciprocal pivoting, an elastic element (28, 38, 48) provided with first (25, 31, 41) and second arms (27, 27′, 27″, 37, 47) and hinged to a pivoting pin (12, 14) of the first rocker (6) at an end thereof, wherein one of said first and second arms of the elastic element (28, 38, 48) exerts an elastic reaction against the member for fixing to the furniture or door and the other arm exerts a reaction on one of the rockers (5, 6), so as to compress the elastic element (28, 38, 48) and to produce a moment generating a pushing force in an opening direction of the door (11) when the hinge is placed in a position defining a closing position of the door (11).

2. Hinge according to claim 1 wherein the elastic element (28, 38, 48) is hinged to the pin (12) connecting the fixing arm (1) to the first rocker (6) and the first arm (25, 31, 41) of the elastic element (28, 38, 48) exerts an elastic reaction on the fixing arm (1) and the second arm (27, 27′, 27″, 37, 47) of the elastic element (28, 38, 48) exerts an elastic reaction on the first rocker (6).

3. Hinge according to claim 1 wherein the elastic element (28, 38, 48) is hinged to the pin (14) connecting the member (7) for fixing to the door (11) to the first rocker (6) and the first arm (25, 31, 41) of the elastic element (28, 38, 48) exerts an elastic reaction on the second rocker (5) and the second arm (27, 27′, 27″, 37, 47) of the elastic element (28, 38, 48) exerts an elastic reaction on the member (7) for fixing to the door (11).

4. Hinge according to claim 2 or wherein the elastic element (28, 38, 48) exerts the elastic reaction for a short arc only of said reciprocal pivoting defining the first part of the door (11) opening.
